(19) United States
(12) Patent Application Publication
(10) Pub. No.: US 2019/0207744 A1
(43) Pub. Date: Jul. 4, 2019

(54) System, Apparatus And Method For Low Overhead Communication Encoding

(71) Applicant: Intel Corporation, Santa Clara, CA (US)

(72) Inventor: Steffen Reinhardt, Nuremburg (DE)

(21) Appl. No.: 16/353,091

(22) Filed: Mar. 14, 2019

(51) Int. Cl. H04L 7/04; H04L 7/00; H04W 56/00; H04L 25/03

(52) U.S. Cl. CPC H04L 7/042; H04L 7/0091; H04L 25/03866; H04W 56/0035; H04W 56/001

(57) ABSTRACT

In one embodiment, an encoder is to receive a symbol word and encode the symbol word into a line code word. The encoder may include: a control block generator to generate at least one control block when the symbol word includes at least one control symbol; a symbol word generator to generate an updated symbol word including the at least one control block, when generated, and one or more data blocks; and a combiner to form the line code word from the updated symbol word and a preamble. Other embodiments are described and claimed.

### TECHNICAL FIELD

Embodiments relate to digital data communications.

### BACKGROUND

Data exchange between integrated circuits often is performed using high speed serial links. There are several standards available that specify a physical layer for such serial links such as MIPI-based specifications including M-PHY and D-PHY, among others. Most of these protocols use a configurable number of differential pairs of lines, referred to as lanes, for the data exchange. While these protocols are used for high speed data transmission, various overheads can consume a substantial portion of the available bandwidth, requiring operation with an increased number of lanes and/or higher frequencies, which can undesirably increase power consumption.

### BRIEF DESCRIPTION OF THE DRAWINGS

FIG. 1 is a block diagram of example communication frames possible using a communication protocol in accordance with an embodiment.

FIG. 2 is a block diagram of example symbols using a communication protocol in accordance with an embodiment.

FIG. 3 is a block diagram of a pure payload word in accordance with an embodiment.

FIG. 4 is a block diagram of a mixed payload/control word in accordance with an embodiment.

FIG. 5 is a block diagram of a first communication formed of an encoding in accordance with an embodiment.

FIG. 6 is a block diagram of a communication circuit in accordance with an embodiment.

FIG. 7 is a high level block diagram of an encoder in accordance with an embodiment.

FIG. 8 is a flow diagram of a method in accordance with an embodiment of the present invention.

FIG. 9 is a flow diagram of a method in accordance with another embodiment of the present invention.

FIG. 10 is an embodiment of a fabric composed of point-to-point links that interconnect a set of components.

FIG. 11 is an embodiment of a system-on-chip design in accordance with an embodiment.

FIG. 12 is a block diagram of a system in accordance with an embodiment of the present invention.

FIG. 13 is a block diagram of an example system with which embodiments can be used.

### DETAILED DESCRIPTION

In various embodiments, an encoder present for a transmitter is configured with an encoding scheme that implements a highly efficient line coding. With this line encoding, embodiments may realize significant power saving for all use cases, and a lesser total number of lanes due to reduced overhead, in turn resulting in smaller die area.

Note that a transmitter in accordance with an embodiment can be incorporated into many different types of communication systems. In some cases, the transmitter may be implemented within hardware circuitry, e.g., of a physical layer (PHY), that outputs information via a communication link to a receiver. In different cases, this receiver may be located locally with the transmitter, e.g., as implemented in different integrated circuits that couple to a common circuit board (which includes the links). In other cases, the transmitter and receiver may be remotely located from each other and the communication may occur via one or more networks. Further understand while the representative embodiments described herein are in the context of serial high speed communication, embodiments are not limited in this regard and the encoding techniques described herein can be used in other communication systems. And while encoding (i.e., transmitter)-based discussion proceeds, understand that a receiver (including a corresponding decoder) may equally implement the techniques described herein to decode such encoded communications.

In principle, the physical layer transmits a bit stream, but in most cases it offers to higher protocol layers a symbol-based interface, meaning that bits are organized in N-bit symbols. On the receiver side, there is some symbol synchronization mechanism to detect symbol boundaries based on embedded information. In embodiments, symbols are 8 bits (1 byte). Commonly used communication protocols for high speed serial communication implement an 8b10b line encoding technique. The 8b10b line coding provides control and comma symbols, DC free communication and short run lengths. However, there is a drawback of a fairly high overhead of 25%. This overhead costs power and area, because the interface gross capacity is dimensioned 25% higher than the maximum capacity, which may consume additional lanes. More advanced line coding schemes like 64b66b and derivatives have much less overhead, but typically have high run length and do not provide mechanisms for fast acquisition of the symbol boundaries.

In an embodiment, an 8b10b coding scheme is replaced with a more efficient 32b35b line coding technique to reduce overhead from 25% down to less than 10%. In embodiments, to allow for clock phase synchronization and tracking, a communication signal may be encoded that includes sufficient transitions from logic zeros to ones and vice versa. This so-called run length gives the maximum number of zeros and ones in a row that can occur for a certain transmission scheme, which may be controlled to be as small as possible. In addition, the communication signal may be controlled to be DC free, meaning in average there may be the same amount of zeros and ones transmitted. It may be possible to embed control information into the communication stream.

In embodiments there are various types of control information to be communicated. For fast initial clock data recovery, a synchronization pattern with multiple zero and one transitions may be used. For symbol synchronization unique sequences in the bit pattern can be advantageously used. These specified symbols can be used for correlation and finding anchor points in the bit pattern. In turn, frame delimiters are used to indicate the higher layer structure of the symbol pattern.

In addition, the encoding scheme further provides features to enable highly reliable communications, reduced synchronization times and so forth. To this end, line coding provides a sequence for fast clock and data recovery (CDR) and fast and reliable symbol synchronization. In addition, embodiments realize a DC free signal, at least on average similar to an 8b10b encoding scheme. Still further, with an encoder in accordance with an embodiment, a run length, which is the longest sequence of logic zeros and ones that can happen, is as short as possible, or at least, a longer run length is at least very unlikely to occur. In an encoding in accordance with an embodiment, frame delimiters are used to indicate frame boundaries. As used herein, the term “frame” is a higher layer logical transport unit, having a variable number of symbols. Still further, such frame delimiters may be generated with an encoding stronger than data symbols, to minimize frame boundary errors. In embodiments, the overhead of the line coding plus the frame delimiters may be less than 10% for a frame length of 60 bytes. In an embodiment, a PHY-to-media access control (MAC) adapter interface is 4-symbol wide, meaning that at each interface cycle, 4 symbols are passed in parallel, where each symbol can either be a data symbol or one of a given set of allowed control symbols. In an embodiment, the physical layer operates in bursts. Each burst is started with a wake-up (prepare) sequence followed by a synchronization pattern and thereafter actual payload data is communicated. A burst is terminated with an all zero sequence, in an embodiment. The physical layer may enter a low power state between bursts. Each burst contains one or several frames which is the basic unit of protocol layers. The start of frame and end of frame are indicated by dedicated control symbols, called frame delimiters. For 32b35b line coding, frame delimiters are neither 8b10b comma symbols nor unique.

With a frame nesting technique, higher priority frames may interrupt regular frames. In an embodiment, there is only one nesting level allowed. Nesting is indicated by an SOF within an ongoing frame.

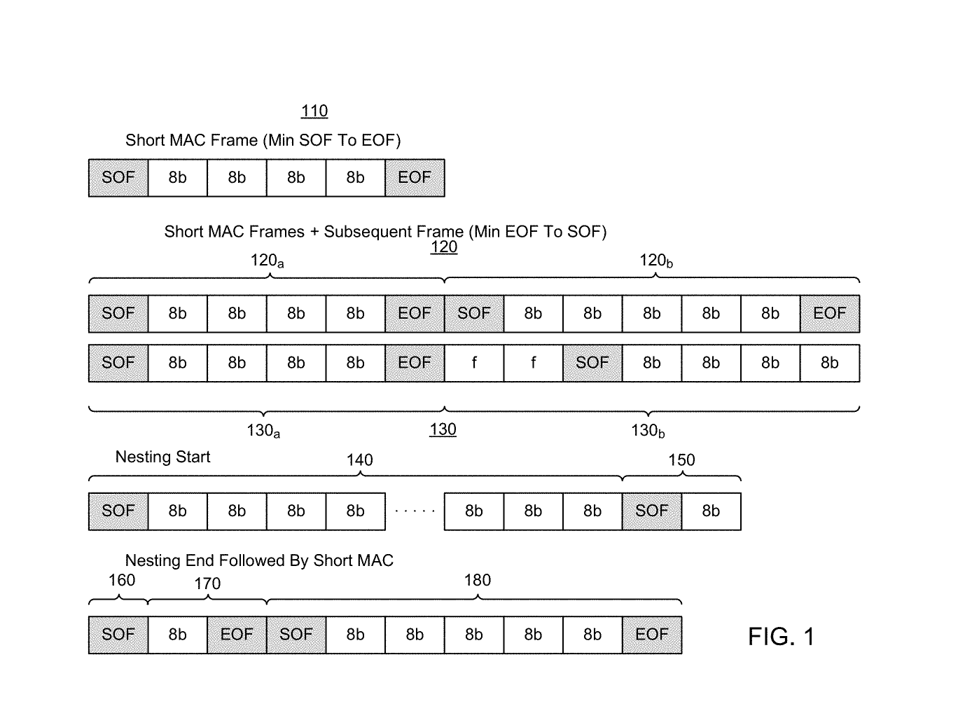

Referring now to FIG. 1, shown is a block diagram of example communication frames possible using a communication protocol in accordance with an embodiment. As illustrated in FIG. 1, a first communication frame 110 may correspond to a short MAC frame that has a minimum number of symbols (here bytes) between a start of frame symbol (a first frame delimiter) and an end of frame control symbol (a second frame delimiter). As illustrated, five bytes of information may be present between these two frame delimiters in frame 110.

Communication frames 120 illustrate two short MAC frames back-to-back in which a start of frame delimiter of a second frame 120_{B} immediately follows an end of frame delimiter of a first frame 120_{A}.

It is also possible for communication to occur with fillers instead present between an end of frame delimiter and a start of frame delimiter. As illustrated in communication frames 130, fillers f are present between a first frame 130_{A} and a second frame 130_{B}.

It is also possible to allow nesting of frames to occur such that a start of frame delimiter for a nested frame may occur within another frame. Thus as illustrated in communication frames 140 and 150, a first frame 140 has a nested frame 150 including a start of frame delimiter that follows a data byte of frame 140.

It is further possible for a nested frame to end with an end of frame delimiter, and an ongoing frame to quickly end, or as a worst case, the nested frame ends directly after the nesting frame has ended. Thus as illustrated, a nested frame 160 concludes with an end of frame delimiter. And thereafter an ongoing frame 170 finishes its data communication with a single byte, followed by an end of frame delimiter. Thereafter, another frame 180 is communicated with start of frame and end of frame delimiters. As such, with these different use cases seen in FIG. 1, there can be cases constructed where 4 frame delimiters surround 6 data symbols. Nevertheless by making use of filler symbols, this can be easily restricted to 3 frame delimiters, whereas filler symbols decreases efficiency of the interface.

In an embodiment, line coding may use a 32b35b line coding scheme that complies with the following protocol parameters. To limit the run length and adapt to an existing interface, the input to line coding circuitry may be 4 symbols (symbol word). To have an efficient line coding for data only symbol words, a payload is 32 bits, to yield a 32b34b line coding in a first step. Each symbol word may be a pure payload word or a mixed control/data word. Note that the 32-bit symbol word is sub-divided into 4 symbols (8 bits each) which can either be data or control symbols. In case of a pure data word, all symbols are data symbols. In case of a mixed data/control word, at least the first symbol is a control symbol. Control symbols may first be encoded with an (8,4) Hamming encoding for protecting such control symbols sufficiently. As such, there may be 4 bits of information within each control symbol. There are mixed data-control words with 1, 2, 3, 4 control symbols (0 control symbols is not supported). Control symbols may be frame delimiters.

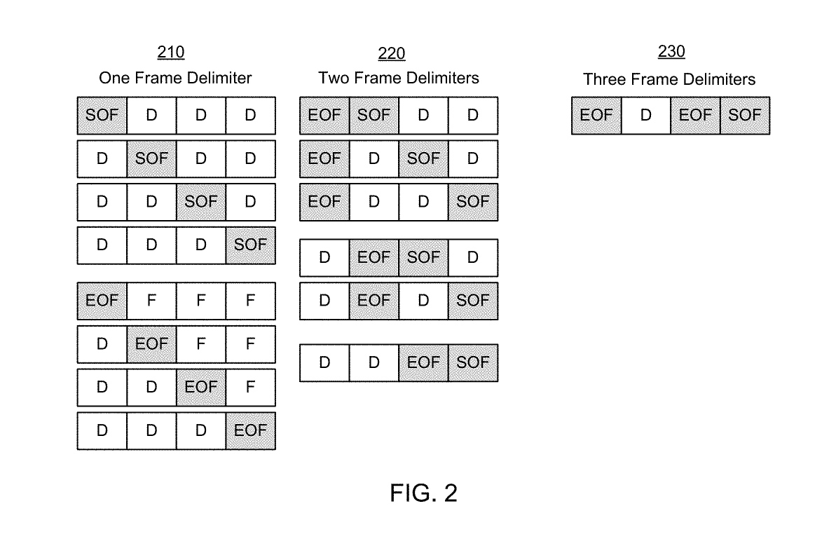

Referring now to FIG. 2 in an example communication protocol, it is possible for up to three control symbols (e.g., frame delimiters) to be present within a symbol word that is formed of four symbols (where each symbol may be 8 bits). Each symbol word is jointly encoded. As illustrated in FIG. 2, example symbol words 210 are illustrated in which a single control symbol, either a start of frame delimiter or an end of frame delimiter, is positioned somewhere within the four bytes that form example symbol words 210. Example symbol words 220 include two control symbols, either a start of frame delimiter or an end of frame delimiter, that are positioned somewhere within the four bytes that form example symbol words 220. Example symbol word 230 includes three control symbols, namely two end of frame delimiters and a start of frame delimiter. With the example symbol words as shown in FIG. 2, in case there is no frame delimiter occurring in the symbol word a “payload word” preamble is used and all 4 bytes are data.

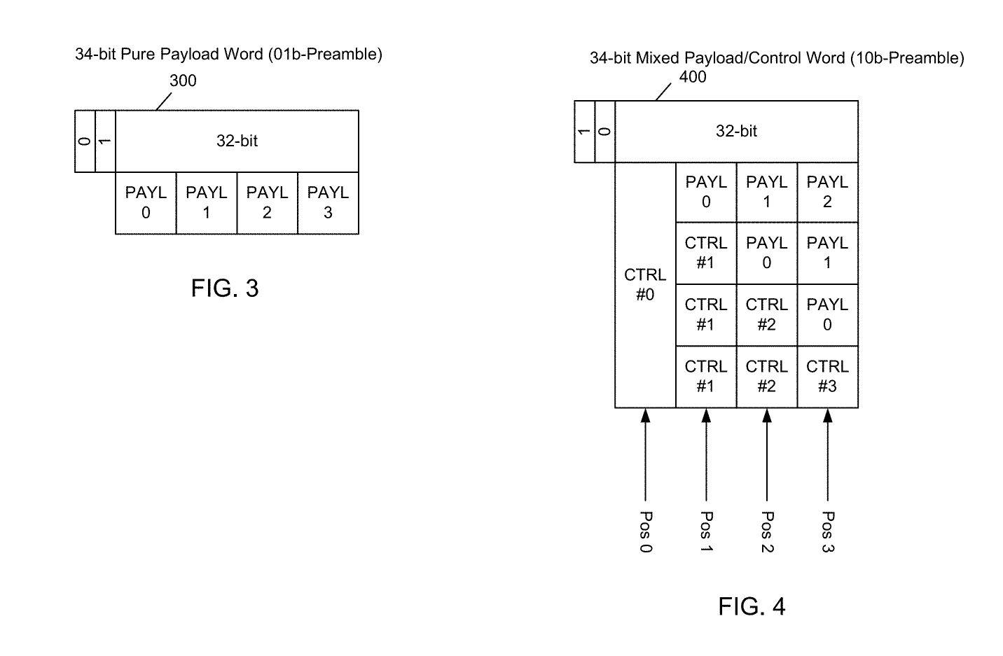

Referring now to FIG. 3, shown is a block diagram of a pure payload word in accordance with an embodiment. As shown in FIG. 3, a payload word 300 includes four bytes of payload data and is appended with a two-bit preamble. As illustrated in the embodiment of FIG. 3, this preamble may be set to a value of “01” to indicate the presence of all payload data within symbol word 300.

In case there is at least one frame delimiter occurring in the symbol word, a “mixed data-payload word” is used, and encoded in the first control byte is the following information: what is the type of the first frame delimiter (SOF, EOF); what is the position of the first frame delimiter (1-4) within the symbol word; and whether there is another frame delimiter. In case there is another frame delimiter, the second byte also is a control byte that encodes: what is the type of the second frame delimiter (SOF, EOF); what is the position of the second frame delimiter (2-4) within the symbol word; and whether there is another frame delimiter. This procedure may be performed with up to 4 frame delimiters, although with the above symbol word examples, there may not be 4 control symbols per symbol word. The bytes following the control bytes are payload bytes carrying data or fillers dependent on frame delimiter context.

Referring now to FIG. 4, shown is a block diagram of a mixed payload/control word in accordance with an embodiment. As shown in FIG. 4, a payload word 400 includes at least one control byte and at least one payload byte and is appended with a two-bit preamble. As illustrated in the embodiment of FIG. 4, this preamble may be set to a value of “10” to indicate the presence of mixed payload/control information within symbol word 400.

In an embodiment, note that the control words (which may take the form of frame delimiters, namely start of frame or end of frame delimiters), may be coded to indicate the type of frame delimiter, without actually communicating the particular frame delimiter itself. More specifically, in an embodiment, a control byte may be encoded using a Hamming code, namely an (8, 4) Hamming code according to the coding in Table 1.

TABLE 1

bit 0: Frame delimiter Type (SOF, EOF)
bit 1-2: position
bit 3: another CTRL
Value 1110b und 1111b are not meaningful and can be used for
1110b: Filler
1111b: Sync

As illustrated in FIG. 4, with a mixed payload/control symbol word 400, a first byte is a control byte (CTRL#0). Then, depending on whether there are additional control bytes, the succeeding bytes of symbol word 400 may be control bytes or payload bytes. While according to one example implementation at most three control words may be present in a mixed payload/control symbol word, it is possible in other implementations that an entire symbol word may be formed of constituent control bytes.

In an embodiment, a 34-bit synchronization word may be used, defined as follows: a “10”b-preamble (mixed data/control) followed by one control byte having a dedicated value for indicating the synchronization word (which in a particular embodiment may have a predetermined value 10101010b), followed by a 24-bit synchronization sequence. In one embodiment, this sequence may include the 10101 . . . b pattern followed by the 0011110100b pattern (10-bit encoded SOF in 8b10b encoding). The first part of the 34-bit synchronization word can then be used for clock and data recovery, and the second part for word boundary detection using correlation. In some cases, the synchronization word may be repeated several times at the start of the frame for CDR settling.

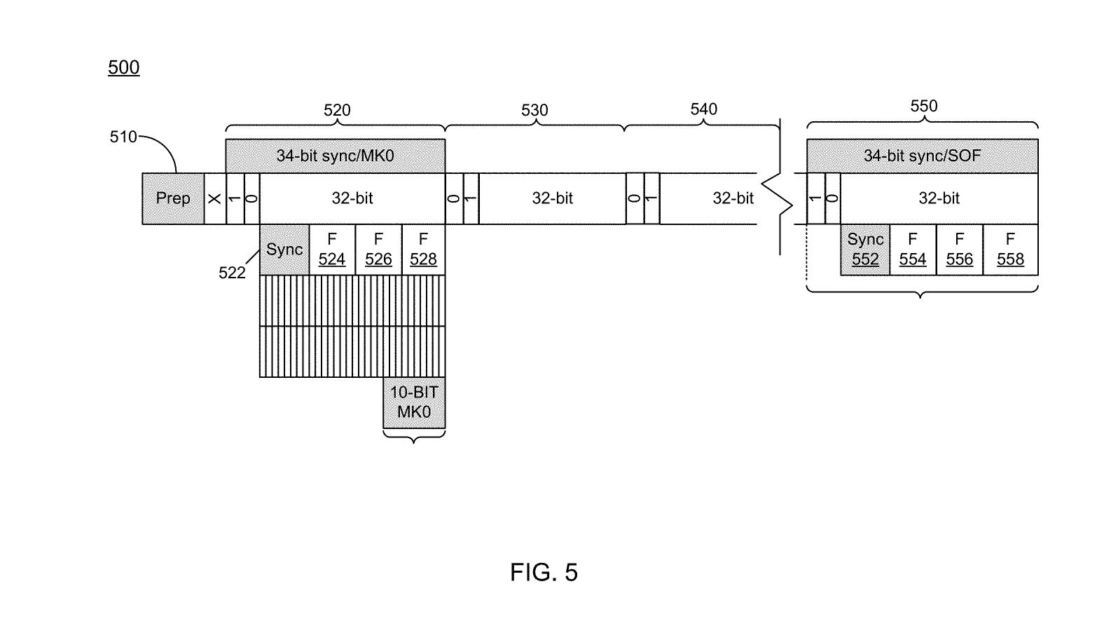

Referring now to FIG. 5, shown is a block diagram of a burst communication formed of an encoding in accordance with an embodiment. As illustrated in FIG. 5, burst communication 500 begins with a preparatory portion 510 which may be, in an embodiment, a predetermined pattern (e.g., all ones). Thereafter, a synchronization symbol word 520 follows. As seen, synchronization word 520 includes a preamble to indicate a combined payload/control word, followed by a synchronization control byte 522, thereafter followed by data bytes 524, 526, 528, which may be a predetermined pattern. Thereafter, multiple pure payload symbol words 530 and 540 occur, with preambles to identify these pure payload symbol words and corresponding four bytes of data each.

Note that in cases of long frames or even continuous mode, the synchronization word may be inserted periodically to allow resynchronization if needed. In case of resynchronization, the correlation is performed as to the complete 34-bit pattern to reduce false detection, as the synchronization word might occur in the bit stream accidentally. As shown, another synchronization symbol word 550 including a synchronization control byte 552, thereafter followed by data bytes 554, 556, 558, may be sent, e.g., on a periodic basis.

In embodiments, run length and DC balance can be optimized by using a scrambler. In one embodiment, an additive scrambler can be used, which is reset to its initial state after each synchronization word. The scrambler scrambles the complete 32-bit word for all data and mixed data/control words, except the synchronization word itself. The scrambler may use the following generator polynomial in an embodiment:

P(x)=x²³+x¹⁸+1 (EQ. 1).

The initial state of the scrambler may be [0100 1010 1010 1111 0101 100], in an embodiment.

In some cases, an additional preamble bit may be used for either indicating a regular 32-bit payload or an inverted 32-bit payload to further optimize DC balance. By maintaining a running disparity, it can be determined whether the regular or the inverted payload is to be selected. In an embodiment, the above features result in a 32b35b coding having the preamble values in Table 2, shown below. Note that the inversion of a word may also be used for avoiding the occurrence of the synchronization sequence within the rest of the bit stream. In case the occurrence of the synchronization sequence (the 32-bits after the preamble) anywhere in the bit pattern is detected on transmission side, the current word is inverted or even re-inverted to avoid occurrence of the sync sequence. False detection is then 100% avoided.

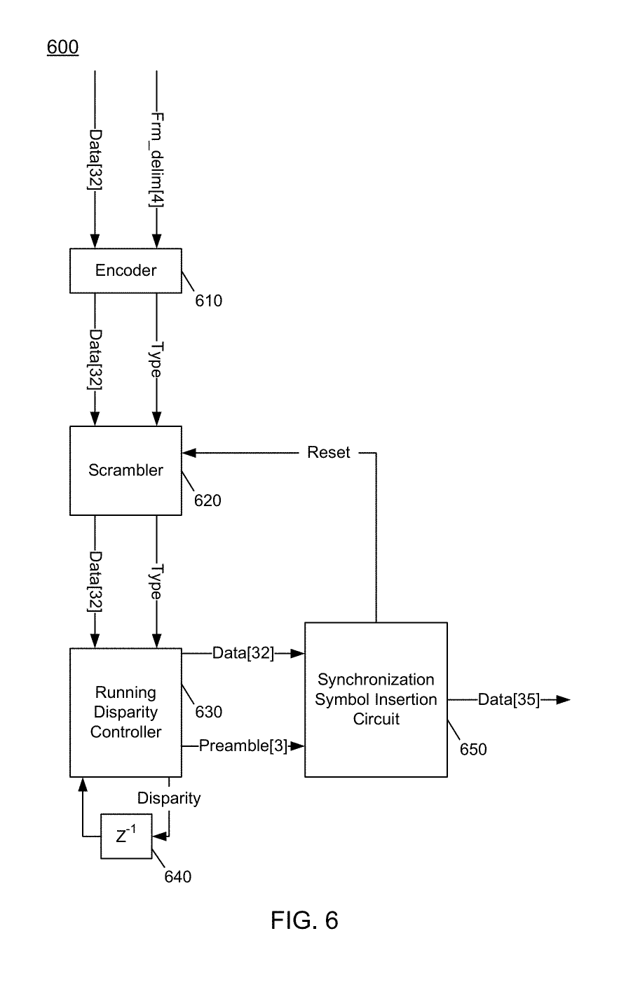

Referring now to FIG. 6, shown is a block diagram of a communication circuit in accordance with an embodiment. As shown in FIG. 6, communication circuit 600 may be part of a transmitter, e.g., a physical unit (PHY) circuit that performs encoding as described herein. As illustrated, communication circuit 600 receives incoming data (e.g., in the form of 32 bit symbol words), which may include payload and/or control bytes and corresponding frame delimiter information. In an embodiment, this frame delimiter information may include information as to presence, type and location of control bytes. In one embodiment, bit 1 and bit 2 in the bit vector encode the position. If bit 1=1 and bit 2=1 then there is a control word in the last position, bit 0 identifies whether it is a SOF or EOF, and bit 3 identifies whether there is another control byte, which cannot happen if bit 1 and bit 2 is set, because then this is already the last control byte. The control symbols are encoded in order.

Based on this information, encoder 610, which in an embodiment may be a 32-b encoder may encode the control information and form the 32-bit payload of the 32b35b line coding word. In any event, line coded data is output, along with an indication of the type of line coded symbol word (e.g., pure payload or a combined payload/control symbol word). The encoded data and this type information is sent to an additive scrambler 620. Note that optional scrambler 620 may scramble the encoded data according to a given polynomial function. In one embodiment, scrambler 620 may operate according to EQ. 1 above.

Still with reference to FIG. 6, the scrambled line coded symbol word and corresponding type information is sent to a running disparity controller 630, which may maintain information regarding a running disparity of the information communicated, using running disparity information of word n−1 from a delay element 640. Note that when a disparity is determined, the data may be inverted. Note further that running disparity controller 630 may generate a preamble based on the type of symbol word and whether the symbol word was inverted for running disparity purposes. As such, running disparity controller 630 may generate a three-bit preamble. In an embodiment, the preamble values may be generated according to the encoding in Table 2 below.

TABLE 2

| Preamble value | Interpretation |
|---|---|
| 010b | Mixed data-control/pure control, regular |
| 110b | Mixed data-control/pure control, inverted |
| 001b | Pure data word, regular |
| 101b | Pure data word, inverted |
| others | not used |

Thereafter the line coded data, which as discussed above may be scrambled and inverted in some cases, is provided through a synchronization symbol insertion circuit 650 and output as a serial bit stream. Note that in embodiments, at a regular interval, synchronization symbol insertion circuit 650 may insert a synchronization symbol within the bit stream to ensure that a receiver maintains synchronization. Note that upon each sending of the synchronization symbol, a reset signal is sent to additive scrambler 620, which causes the polynomial function to be reset. Understand while shown at this high level in the embodiment of FIG. 6, many variations and alternatives are possible.

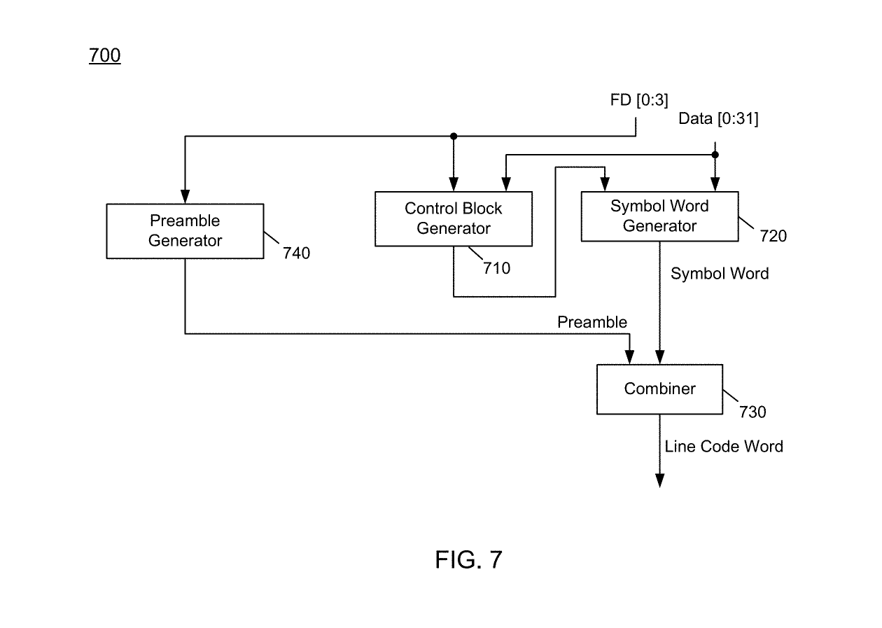

Referring now to FIG. 7, shown is a high level block diagram of an encoder in accordance with an embodiment. As shown in FIG. 7, encoder 700 may correspond to encoder 610 in the implementation of FIG. 6. As such, encoder 700 is configured to receive incoming symbol words (Data[0:31]) and corresponding frame delimiter information (FD[0:3]). In an implementation in which symbol words are 32 bits, this symbol word may be received as four bytes, which may all be data, or one or more of the bytes may be a given frame delimiter (either an SOF or EOF). To determine the number and location of control symbols within a symbol word, the frame delimiter information further may be received in encoder 700. In an embodiment, this frame delimiter information may take the form of a bit vector, with each bit indicating whether the corresponding byte of the symbol word is a frame delimiter.

As illustrated in FIG. 7, encoder 700 includes a control block generator 710 which may generate control blocks (namely control bytes) based on the frame delimiter information. As described herein, control block generator 710 may be configured to apply an encoding as in Table 1 to generate a control byte (encoded) for each received control symbol in the incoming data stream (Data[0:31]). As described above, each such control byte includes an indication of the type of frame delimiter, its location within the symbol word, and whether another symbol is located within the symbol word. As such, control block generator 710 may generate between one and four control bytes. In a protocol scheme as described above with a maximum of three control symbols present in a symbol word, at a maximum only three such control bytes may be generated.

As shown, the one or more control bytes are provided to a symbol word generator 720, along with the incoming symbol word. In an embodiment, symbol word generator 720 may generate a symbol word. To this end, if there is a single control byte, symbol word generator 720 includes that control byte as the first byte of the symbol word. Then three data bytes follow. Symbol word generator 720 thus in effect replaces the received control word with this control byte and further manipulates the position of this control byte so that it is the first byte of the symbol word. Similar operation to include additional control bytes (and remove the corresponding received control symbols) occurs for additional control bytes of the symbol word. As such, symbol word generator 720 outputs a symbol word formed of four bytes, and which may include all payload, or a combination of one or more control bytes and payload bytes.

With further reference to FIG. 7, a combiner 730 is configured to receive this symbol word and output a corresponding line code word, by appending a preamble as generated in a preamble generator 740. As such combiner 730 outputs a line code word according to the given encoding scheme.

Also illustrated in FIG. 7, preamble generator 740 is further coupled to receive the incoming frame delimiter information. Based on this information, preamble generator 740 may generate, e.g., a two-bit or three-bit preamble to indicate whether the corresponding symbol word is a payload only symbol word or a combined control/payload symbol word as described above. Understand while shown at this high level in the embodiment of FIG. 7, many variations and alternatives are possible.

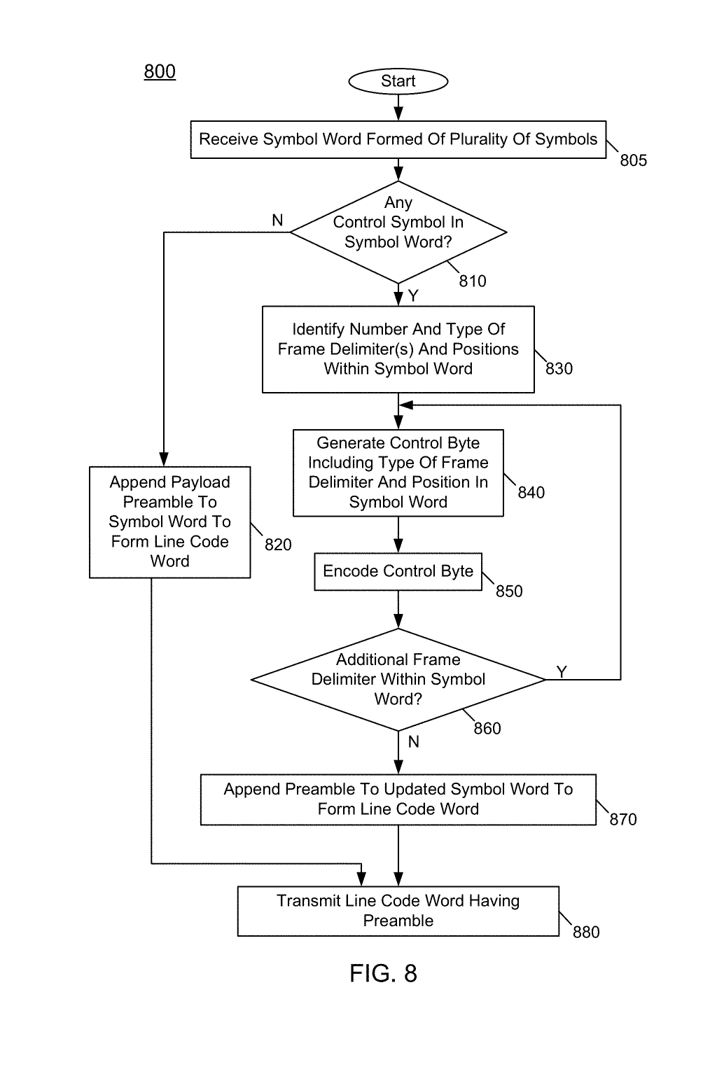

Referring now to FIG. 8, shown is a flow diagram of a method in accordance with an embodiment of the present invention. As shown in FIG. 8, method 800 is a method for performing line coding in accordance with an embodiment. Method 800 may be performed by encoding circuitry of a transmitter such as may be implemented in interface circuitry between radio frequency (RF) circuitry and baseband circuitry. As such, method 800 may be performed by hardware circuitry, firmware, software and/or combinations thereof.

As illustrated, method 800 begins by receiving a symbol word formed of a plurality of symbols (block 805). Such symbol word may be received in the encoder from a higher level layer, such as a protocol or link layer. In the examples described herein, this symbol word may be formed of four 8-bit symbols, each of which may be payload data or a control symbol, e.g., a frame delimiter (e.g., an SOF or EOF). Next it is determined whether any control symbols are present in the symbol word (diamond 810). In an embodiment, this determination may be based on frame delimiter information received with the symbol word. If not, control passes to block 820 where a line code word is formed with a payload preamble appended to this symbol word (block 820). More specifically in this instance the preamble indicates that the line code word is a payload word. Next at block 880 this line code word with its preamble is transmitted. In an embodiment, a transmitter coupled to the encoder may transmit this line code word, e.g., as a high speed serial bit stream.

Still with reference to FIG. 8, instead if it is determined that there is at least one control symbol within the symbol word, control passes from diamond 810 to block 830, where the number and type of frame delimiters (and their positions within the symbol word) may be determined. In an embodiment, this information may be determined based on the frame delimiter information. Next at block 840 a control byte is generated for a first control symbol that includes a type of the control symbol, and its position within the symbol word. Note that this control byte may further include information to indicate whether another control symbol is present within the symbol word. Next, this control byte may be encoded (block 850). In one embodiment, an (8, 4) Hamming code may be applied to the control byte to form an encoded control byte. At diamond 860 it is determined whether an additional frame delimiter is present with the symbol word. If so, control passes back to block 840 discussed above.

If no further frame delimiters are present within the symbol word, control passes to block 870 where, after manipulating the symbol word to place the control bytes at the beginning, a line code word is formed by appending a preamble to the updated symbol word. Here this preamble indicates presence in the line code word of combined information, including both control information and payload information. Thereafter, this line code word with its included preamble is transmitted (block 880). Although shown at this high level in the embodiment of FIG. 8, many variations and alternatives are possible.

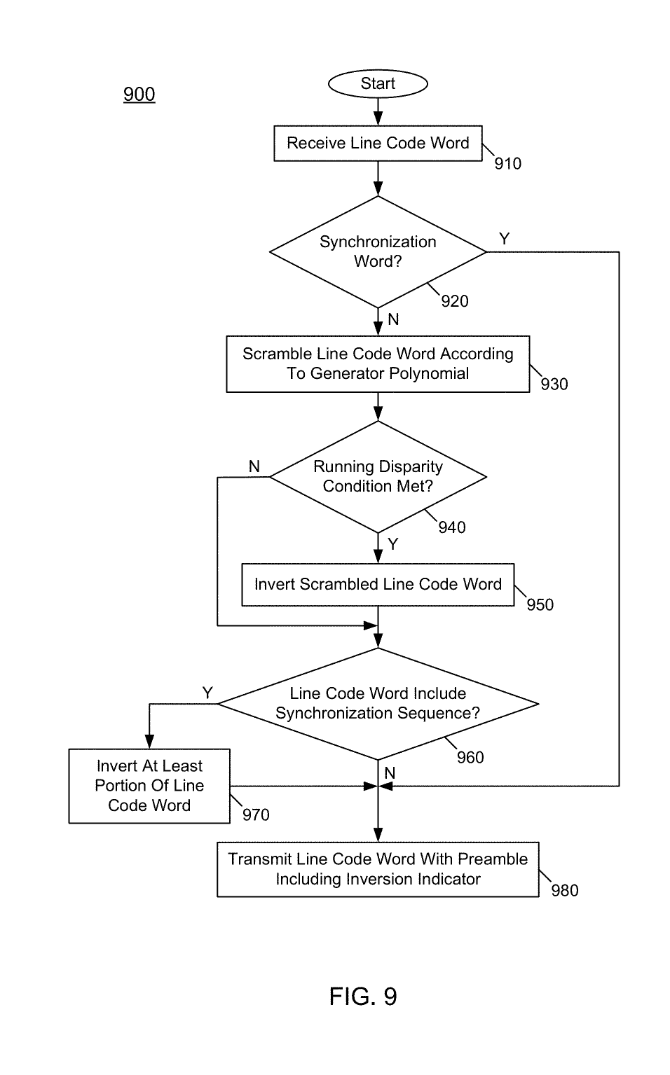

Referring now to FIG. 9, shown is a flow diagram of a method in accordance with another embodiment of the present invention. As shown in FIG. 9, method 900 is a method for performing further encoding of symbol words to provide for improved communication accuracy and fast synchronization by way of inclusion of synchronization words, run length disparity control and so forth. As such, method 900 may be performed by encoding circuitry of a transmitter such as described above. As such, method 900 may be performed by hardware circuitry, firmware, software and/or combinations thereof.

As illustrated, method 900 begins by receiving a line code word (block 910). Note that this line code word may be received following line coding, e.g., performed as discussed above with regard to FIG. 8. Thereafter, it is determined whether the line code word is a synchronization word (diamond 920). If so, this line code word is transmitted with a preamble (block 980). Here this preamble may indicate the presence of combined control and payload information and further may include another bit or other indicator to indicate that no inversion has been applied to this synchronization word.

Instead if it is determined that the line code word is not to be a synchronization word, control passes to block 930 where the line code word is scrambled. In an embodiment, a given generator polynomial may be used to perform scrambling of this line code word. Next it is determined at diamond 940 whether a running disparity condition is met. For example, the condition may relate to a sign of the running disparity and a sign of the current disparity. If the running disparity condition is met, control passes to block 950 where the scrambled line code word is inverted. As an example of this running disparity operation, assume word n is encoded and the running disparity after word n−1 is known. The disparity of word n is calculated. If both have the same sign, the word n is inverted to move disparity in direction of 0.

Still referring to FIG. 9, it is determined whether the line code word as processed includes the synchronization sequence (diamond 960). As discussed above, the synchronization sequence may correspond to a predetermined pattern. To avoid erroneous detection of a synchronization message, if it is determined that any portion of the line code word includes the synchronization sequence, control passes to block 970 where at least a portion of the line code word may be inverted so that the synchronization pattern is no longer present. To this end, the sync sequence is searched for in the transmit bit stream with a correlation filter. If the filter detects the sync sequence (even across word boundaries) after encoding of word n (and passing the word n through the correlation filter), word n is inverted to break the correlation. At the conclusion of whatever processing is performed in method 900, the line code word with a preamble is transmitted (block 980). Understand while shown at this high level in the embodiment of FIG. 9, many variations and alternatives are possible.

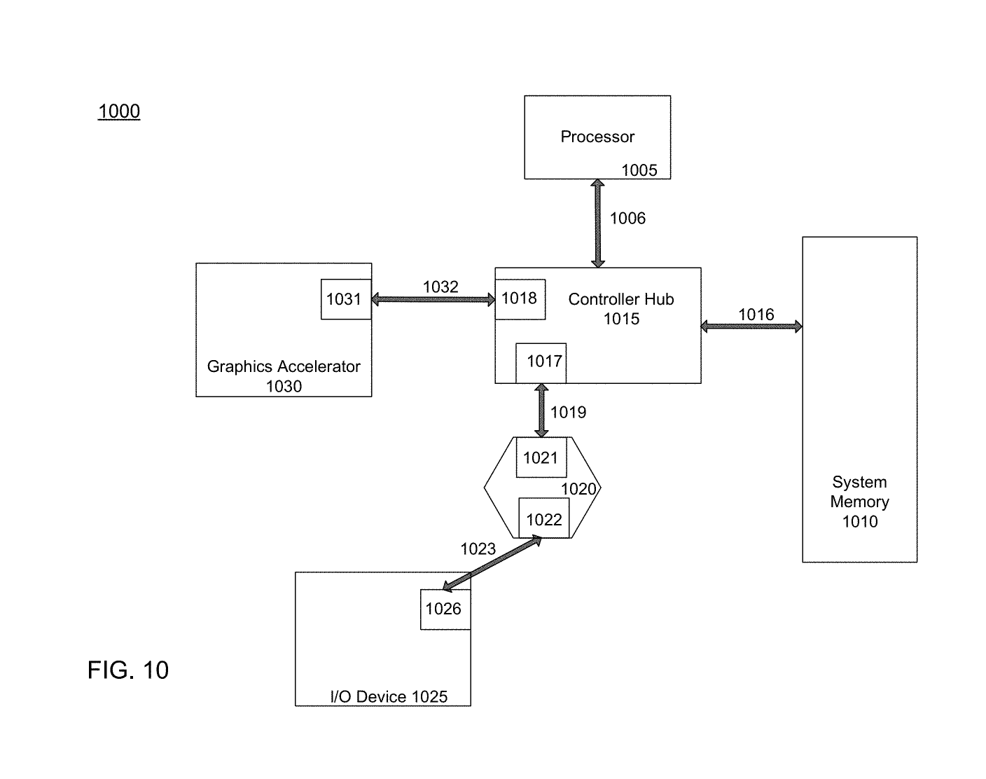

Embodiments may be implemented in a wide variety of interconnect structures. Referring to FIG. 10, an embodiment of a fabric composed of point-to-point links that interconnect a set of components is illustrated. System 1000 includes processor 1005 and system memory 1010 coupled to controller hub 1015. Processor 1005 includes any processing element, such as a microprocessor, a host processor, an embedded processor, a co-processor, or other processor. Processor 1005 is coupled to controller hub 1015 through front-side bus (FSB) 1006. In one embodiment, FSB 1006 is a serial point-to-point interconnect. In another embodiment, link 1006 includes a parallel serial, differential interconnect architecture that is compliant with different interconnect standards, and which may perform efficient encoding and decoding of data and control symbols as described herein.

System memory 1010 includes any memory device, such as random access memory (RAM), non-volatile (NV) memory, or other memory accessible by devices in system 1000. System memory 1010 is coupled to controller hub 1015 through memory interface 1016. Examples of a memory interface include a double-data rate (DDR) memory interface, a dual-channel DDR memory interface, and a dynamic RAM (DRAM) memory interface.

In one embodiment, controller hub 1015 is a root hub, root complex, or root controller in a PCIe interconnection hierarchy. Examples of controller hub 1015 include a chip set, a memory controller hub (MCH), a northbridge, an interconnect controller hub (ICH), a southbridge, and a root controller/hub. Often the term chip set refers to two physically separate controller hubs, i.e. a memory controller hub (MCH) coupled to an interconnect controller hub (ICH). Note that current systems often include the MCH integrated with processor 1005, while controller 1015 is to communicate with I/O devices, in a similar manner as described below. In some embodiments, peer-to-peer routing is optionally supported through root complex 1015.

Here, controller hub 1015 is coupled to switch/bridge 1020 through serial link 1019. Input/output modules 1017 and 1021, which may also be referred to as interfaces/ports 1017 and 1021, include/implement a layered protocol stack to provide communication between controller hub 1015 and switch 1020. In one embodiment, multiple devices are capable of being coupled to switch 1020.

Switch/bridge 1020 routes packets/messages from device 1025 upstream, i.e., up a hierarchy towards a root complex, to controller hub 1015 and downstream, i.e., down a hierarchy away from a root controller, from processor 1005 or system memory 1010 to device 1025. Switch 1020, in one embodiment, is referred to as a logical assembly of multiple virtual PCI-to-PCI bridge devices. Device 1025 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices and which may be coupled via an I3C bus, as an example. Often in the PCIe vernacular, such a device is referred to as an endpoint. Although not specifically shown, device 1025 may include a PCIe to PCI/PCI-X bridge to support legacy or other version PCI devices. Endpoint devices in PCIe are often classified as legacy, PCIe, or root complex integrated endpoints.

Graphics accelerator 1030 is also coupled to controller hub 1015 through serial link 1032. In one embodiment, graphics accelerator 1030 is coupled to an MCH, which is coupled to an ICH. Switch 1020, and accordingly I/O device 1025, is then coupled to the ICH. I/O modules 1031 and 1018 are also to implement a layered protocol stack to communicate between graphics accelerator 1030 and controller hub 1015. A graphics controller or the graphics accelerator 1030 itself may be integrated in processor 1005. Understand that interfaces for various links described above may perform efficient encoding and decoding of data and control symbols as described herein.

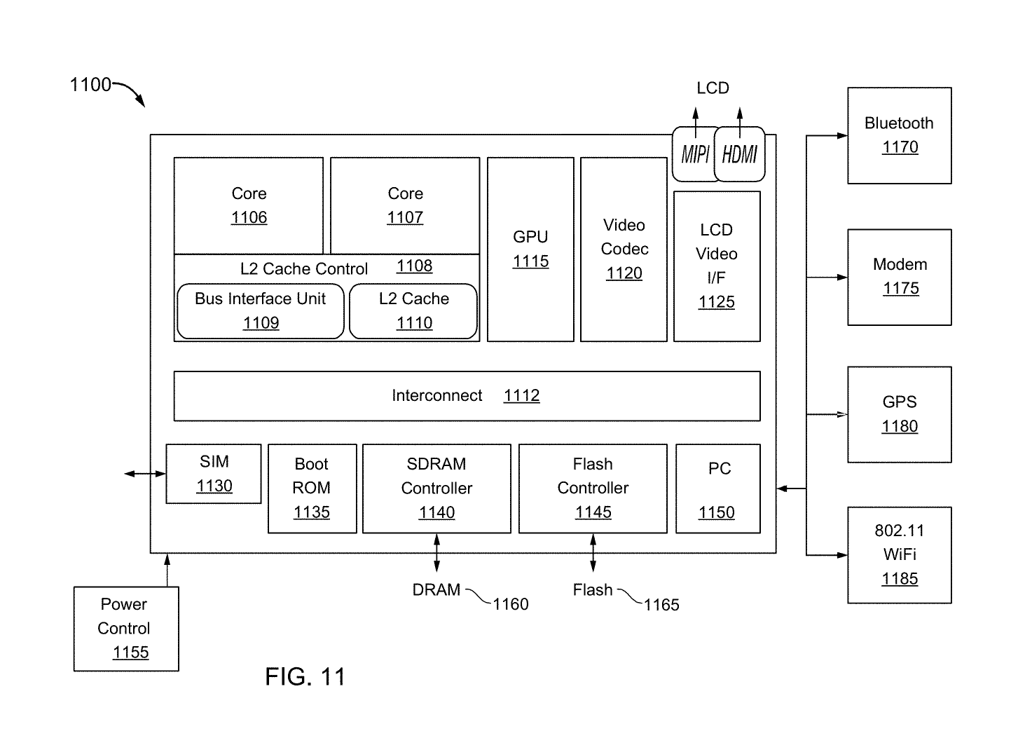

Turning next to FIG. 11, an embodiment of a SoC design in accordance with an embodiment is depicted. As a specific illustrative example, SoC 1100 may be configured for insertion in any type of computing device, ranging from portable device to server system. Here, SoC 1100 includes 2 cores 1106 and 1107. Cores 1106 and 1107 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 1106 and 1107 are coupled to cache control 1108 that is associated with bus interface unit 1109 and L2 cache 1110 to communicate with other parts of system 1100 via an interconnect 1112.

Interconnect 1112 provides communication channels to the other components, such as a Subscriber Identity Module (SIM) 1130 to interface with a SIM card, a boot ROM 1135 to hold boot code for execution by cores 1106 and 1107 to initialize and boot SoC 1100, a SDRAM controller 1140 to interface with external memory (e.g., DRAM 1160), a flash controller 1145 to interface with non-volatile memory (e.g., flash 1165), a peripheral controller 1150 (e.g., an eSPI interface) to interface with peripherals, video codecs 1120 and video interface 1125 to display and receive input (e.g., touch enabled input), GPU 1115 to perform graphics related computations, etc. Any of these interconnects/interfaces may incorporate aspects described herein, including the efficient coding and decoding of data and control symbols. In addition, the system illustrates peripherals for communication, such as a Bluetooth module 1170, 3G modem 1175, GPS 1180, and WiFi 1185. Also included in the system is a power controller 1155. To this end, interface, partially for baseband to RF interfaces may perform efficient encoding and decoding of data and control symbols as described herein.

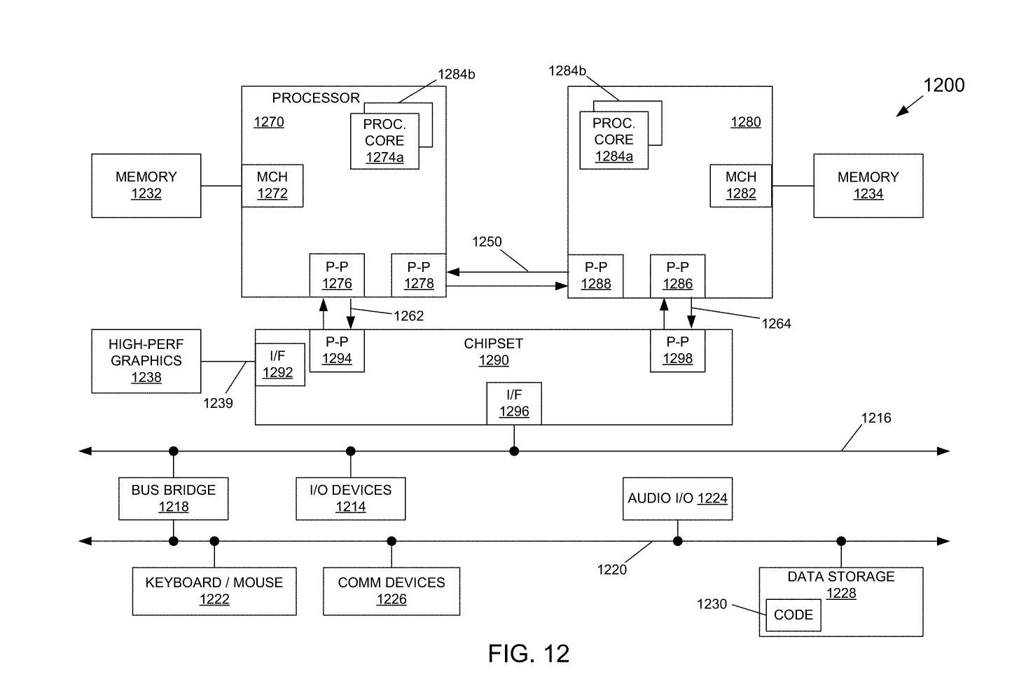

Referring now to FIG. 12, shown is a block diagram of a system in accordance with an embodiment of the present invention. As shown in FIG. 12, multiprocessor system 1200 includes a first processor 1270 and a second processor 1280 coupled via a point-to-point interconnect 1250. As shown in FIG. 12, each of processors 1270 and 1280 may be many core processors including representative first and second processor cores (i.e., processor cores 1274a and 1274b and processor cores 1284a and 1284b).

Still referring to FIG. 12, first processor 1270 further includes a memory controller hub (MCH) 1272 and point-to-point (P-P) interfaces 1276 and 1278. Similarly, second processor 1280 includes a MCH 1282 and P-P interfaces 1286 and 1288. As shown in FIG. 12, MCH's 1272 and 1282 couple the processors to respective memories, namely a memory 1232 and a memory 1234, which may be portions of system memory (e.g., DRAM) locally attached to the respective processors. First processor 1270 and second processor 1280 may be coupled to a chipset 1290 via P-P interconnects 1262 and 1264, respectively. As shown in FIG. 12, chipset 1290 includes P-P interfaces 1294 and 1298.

Furthermore, chipset 1290 includes an interface 1292 to couple chipset 1290 with a high performance graphics engine 1238, by a P-P interconnect 1239. As shown in FIG. 12, various input/output (I/O) devices 1214 may be coupled to first bus 1216, along with a bus bridge 1218 which couples first bus 1216 to a second bus 1220. Various devices may be coupled to second bus 1220 including, for example, a keyboard/mouse 1222, communication devices 1226 and a data storage unit 1228 such as a disk drive or other mass storage device which may include code 1230, in one embodiment. Further, an audio I/O 1224 may be coupled to second bus 1220. Any of the devices shown in FIG. 12 may include interfaces to perform efficient encoding and decoding of data and control symbols, as described herein.

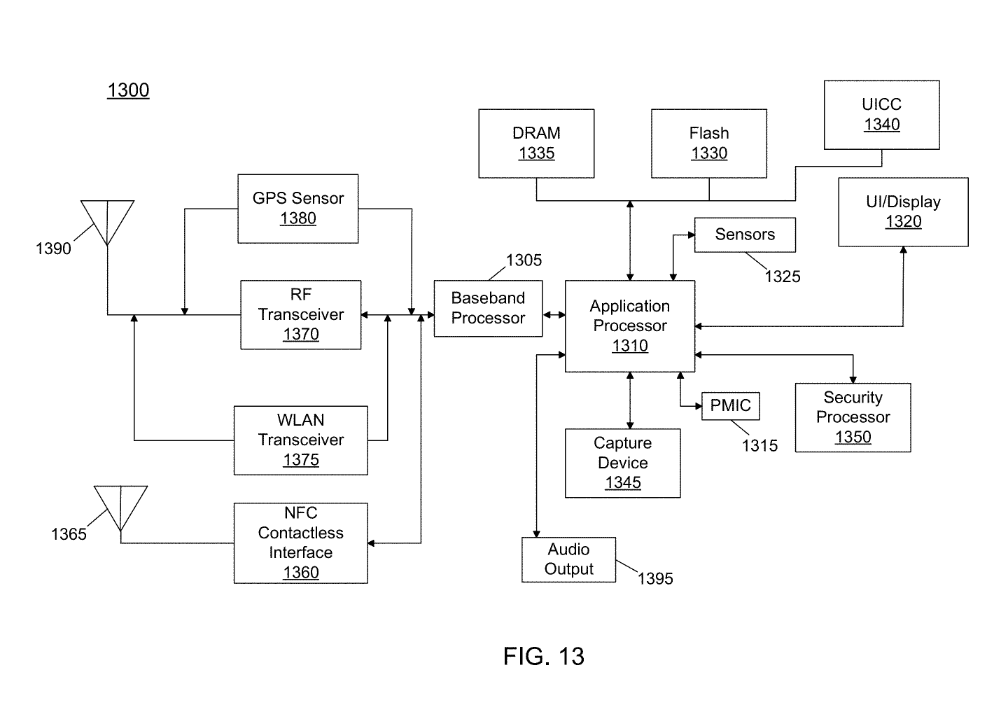

Referring now to FIG. 13, shown is a block diagram of an example system with which embodiments can be used. As seen, system 1300 may be a smartphone or other wireless communicator. A baseband processor 1305 is configured to perform various signal processing with regard to communication signals to be transmitted from or received by the system. In turn, baseband processor 1305 is coupled to an application processor 1310, which may be a main CPU of the system to execute an OS and other system software, in addition to user applications such as many well-known social media and multimedia apps. Application processor 1310 may further be configured to perform a variety of other computing operations for the device.

In turn, application processor 1310 can couple to a user interface/display 1320, e.g., a touch screen display. In addition, application processor 1310 may couple to a memory system including a non-volatile memory, namely a flash memory 1330 and a system memory, namely a dynamic random access memory (DRAM) 1335. As further seen, application processor 1310 further couples to a capture device 1340 such as one or more image capture devices that can record video and/or still images.

Still referring to FIG. 13, a universal integrated circuit card (UICC) 1340 comprising a subscriber identity module and possibly a secure storage and cryptoprocessor is also coupled to application processor 1310. System 1300 may further include a security processor 1350 that may couple to application processor 1310. A plurality of sensors 1325 may couple to application processor 1310 to enable input of a variety of sensed information such as accelerometer and other environmental information. An audio output device 1395 may provide an interface to output sound, e.g., in the form of voice communications, played or streaming audio data and so forth.

As further illustrated, a near field communication (NFC) contactless interface 1360 is provided that communicates in a NFC near field via an NFC antenna 1365. While separate antennae are shown in FIG. 13, understand that in some implementations one antenna or a different set of antennae may be provided to enable various wireless functionality.

A PMIC 1315 couples to application processor 1310 to perform platform level power management. To this end, PMIC 1315 may issue power management requests to application processor 1310 to enter certain low power states as desired. Furthermore, based on platform constraints, PMIC 1315 may also control the power level of other components of system 1300.

To enable communications to be transmitted and received, various circuitry may be coupled between baseband processor 1305 and an antenna 1390. Specifically, a radio frequency (RF) transceiver 1370 and a wireless local area network (WLAN) transceiver 1375 may be present. In general, RF transceiver 1370 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 1380 may be present. Other wireless communications such as receipt or transmission of radio signals, e.g., AM/FM and other signals may also be provided. In addition, via WLAN transceiver 1375, local wireless communications can also be realized. In embodiments, a baseband-RF interface in connection with baseband processor 1305 and the various RF circuitry may perform efficient encoding and decoding of data and control symbols as described herein.

The following examples pertain to further embodiments.

In one example, an apparatus includes: an encoder to receive a symbol word and encode the symbol word into a line code word. The encoder comprises: a control block generator to generate at least one control block when the symbol word includes at least one control symbol; a symbol word generator to generate an updated symbol word including the at least one control block, when generated, and one or more data blocks; and a combiner to form the line code word from the updated symbol word and a preamble. The apparatus may further include a transmitter coupled to the encoder to transmit the line code word to a receiver.

In an example, the encoder further comprises a preamble generator to generate the preamble to indicate whether the line code word includes the at least one control symbol.

In an example, the preamble generator is to: generate the preamble having a first code to indicate that the line code word includes the at least one control symbol; and generate a second preamble for a second line code word, the second preamble to indicate that the second line code word comprises a payload symbol word.

In an example, the apparatus further comprises a scrambler to scramble the line code word before the line code word is transmitted.

In an example, the scrambler is to scramble the line code word according to a polynomial generator.

In an example, the apparatus further comprises an inverter to invert the scrambled line code word when a disparity measure meets a disparity condition.

In an example, the scrambler is to reset the polynomial generator in response to communication of a synchronization word.

In an example, the control block generator is to encode the at least one control symbol into a first encoded control block according to a first encoding scheme, comprising a Hamming code and the encoder is to line code the line code word according to an xbyb encoding scheme.

In another example, a method comprises: receiving, in an encoder of a transmitter, a symbol word comprising a plurality of symbols; generating, for a first control symbol of the plurality of symbols, a first control byte to indicate a type of the first control symbol and a position of the first control symbol within the plurality of symbols; encoding the first control byte and at least one data symbol of the plurality of symbols to form an updated symbol word; and transmitting a line code word comprising the updated symbol word from the transmitter to a receiver via a link.

In an example, the method further comprises appending a preamble to the updated symbol word before transmitting the line code word.

In an example, the preamble is to indicate presence of at least one control byte in the line code word.

In an example, the method further comprises: encoding the first control byte according to a Hamming code to form an encoded first control byte; and encoding the encoded first control byte and the at least one data symbol according to an xbyb encoding scheme.

In an example, the method further comprises: receiving, in the encoder, a second symbol word comprising a second plurality of symbols; encoding the second code word to form a second symbol word; appending a second preamble to the second symbol word to indicate presence of payload data in the second symbol word; and transmitting a second line code word with the second preamble and the second symbol word from the transmitter to the receiver.

In an example, the method further comprises: prior to a burst communication, generating a synchronization word comprising a predetermined control byte and a predetermined payload pattern; appending a preamble to the synchronization word; and transmitting the synchronization word and the preamble from the transmitter to the receiver.

In an example, the method further comprises transmitting the synchronization word a plurality of times during the burst communication.

In an example, the method further comprises inverting at least a portion of the line code word when the line code word includes the predetermined payload pattern.

In an example, the method further comprises: scrambling the line code word before transmitting the line code word; and inverting the scrambled line code word based on a disparity condition.

In another example, a computer readable medium including instructions is to perform the method of any of the above examples.

In a further example, a computer readable medium including data is to be used by at least one machine to fabricate at least one integrated circuit to perform the method of any one of the above examples.

In a still further example, an apparatus comprises means for performing the method of any one of the above examples.

In another example, a system comprises a first integrated circuit comprising a transmitter and a second integrated circuit comprising a receiver. The transmitter comprises: an encoder to receive a symbol word including at least one control symbol and at least one data symbol, where the encoder is to first encode the at least one control symbol with a first encoding and second encode the encoded at least one control symbol and the at least one data symbol with a second encoding to form a line code word; a scrambler coupled to the encoder to scramble the line code word to form an encoded line code word; a disparity controller to invert the encoded line code word based on a disparity measure; and an output circuit to output the encoded line code word. The second integrated circuit may be coupled to the first integrated circuit via a communication link. In turn, the receiver may include a decoder to decode the encoded line code word to obtain the symbol word.

In an example, the encoder comprises: a first generator to generate the encoded at least one control symbol, the encoded at least one control symbol to indicate presence of and a location of the at least one control symbol in the symbol word; and a second generator to generate an updated symbol word including the encoded at least one control symbol and the at least one data symbol.

In an example, the encoder comprises a preamble generator to: generate a preamble having a first code for the line code word, the first code to indicate that the line code word includes the at least one control symbol; and generate a second preamble having a second code for a second line code word, the second code to indicate that the second line code word comprises a payload symbol word.

Understand that various combinations of the above examples are possible.

Note that the terms “circuit” and “circuitry” are used interchangeably herein. As used herein, these terms and the term “logic” are used to refer to alone or in any combination, analog circuitry, digital circuitry, hard wired circuitry, programmable circuitry, processor circuitry, microcontroller circuitry, hardware logic circuitry, state machine circuitry and/or any other type of physical hardware component. Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. Still further embodiments may be implemented in a computer readable storage medium including information that, when manufactured into a SoC or other processor, is to configure the SoC or other processor to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
an encoder to receive a symbol word and encode the symbol word into a line code word, the encoder comprising:
a control block generator to generate at least one control block when the symbol word includes at least one control symbol;
a symbol word generator to generate an updated symbol word including the at least one control block, when generated, and one or more data blocks; and
a combiner to form the line code word from the updated symbol word and a preamble; and
a transmitter coupled to the encoder to transmit the line code word to a receiver.

2. The apparatus of claim 1, wherein the encoder further comprises a preamble generator to generate the preamble to indicate whether the line code word includes the at least one control symbol.

3. The apparatus of claim 2, wherein the preamble generator is to:
generate the preamble having a first code to indicate that the line code word includes the at least one control symbol; and
generate a second preamble for a second line code word, the second preamble to indicate that the second line code word comprises a payload symbol word.

4. The apparatus of claim 1, further comprising a scrambler to scramble the line code word before the line code word is transmitted.

5. The apparatus of claim 4, wherein the scrambler is to scramble the line code word according to a polynomial generator.

6. The apparatus of claim 4, further comprising an inverter to invert the scrambled line code word when a disparity measure meets a disparity condition.

7. The apparatus of claim 4, wherein the scrambler is to reset the polynomial generator in response to communication of a synchronization word.

8. The apparatus of claim 1, wherein the control block generator is to encode the at least one control symbol into a first encoded control block according to a first encoding scheme, comprising a Hamming code and the encoder is to line code the line code word according to an xbyb encoding scheme.

9. A machine-readable medium having stored thereon instructions, which if performed by a machine cause the machine to perform a method comprising:
receiving, in an encoder of a transmitter, a symbol word comprising a plurality of symbols;
generating, for a first control symbol of the plurality of symbols, a first control byte to indicate a type of the first control symbol and a position of the first control symbol within the plurality of symbols;
encoding the first control byte and at least one data symbol of the plurality of symbols to form an updated symbol word; and
transmitting a line code word comprising the updated symbol word from the transmitter to a receiver via a link.

10. The machine-readable medium of claim 9, wherein the method further comprises appending a preamble to the updated symbol word before transmitting the line code word.

11. The machine-readable medium of claim 10, wherein the preamble is to indicate presence of at least one control byte in the line code word.

12. The machine-readable medium of claim 9, wherein the method further comprises:
encoding the first control byte according to a Hamming code to form an encoded first control byte; and
encoding the encoded first control byte and the at least one data symbol according to an xbyb encoding scheme.

13. The machine-readable medium of claim 9, wherein the method further comprises:
receiving, in the encoder, a second symbol word comprising a second plurality of symbols;
encoding the second code word to form a second symbol word;
appending a second preamble to the second symbol word to indicate presence of payload data in the second symbol word; and
transmitting a second line code word with the second preamble and the second symbol word from the transmitter to the receiver.

14. The machine-readable medium of claim 9, wherein the method further comprises:
prior to a burst communication, generating a synchronization word comprising a predetermined control byte and a predetermined payload pattern;
appending a preamble to the synchronization word; and
transmitting the synchronization word and the preamble from the transmitter to the receiver.

15. The machine-readable medium of claim 14, wherein the method further comprises transmitting the synchronization word a plurality of times during the burst communication.

16. The machine-readable medium of claim 14, wherein the method further comprises inverting at least a portion of the line code word when the line code word includes the predetermined payload pattern.

17. The machine-readable medium of claim 9, wherein the method further comprises:
scrambling the line code word before transmitting the line code word; and
inverting the scrambled line code word based on a disparity condition.

18. A system comprising:
a first integrated circuit comprising a transmitter, the transmitter comprising:
an encoder to receive a symbol word including at least one control symbol and at least one data symbol, wherein the encoder is to first encode the at least one control symbol with a first encoding and second encode the encoded at least one control symbol and the at least one data symbol with a second encoding to form a line code word;
a scrambler coupled to the encoder to scramble the line code word to form an encoded line code word;
a disparity controller to invert the encoded line code word based on a disparity measure; and
an output circuit to output the encoded line code word; and
a second integrated circuit coupled to the first integrated circuit via a communication link, the second integrated circuit comprising a receiver, the receiver comprising a decoder to decode the encoded line code word to obtain the symbol word.

19. The system of claim 18, wherein the encoder comprises:
a first generator to generate the encoded at least one control symbol, the encoded at least one control symbol to indicate presence of and a location of the at least one control symbol in the symbol word; and
a second generator to generate an updated symbol word including the encoded at least one control symbol and the at least one data symbol.

20. The system of claim 18, wherein the encoder comprises a preamble generator to:
generate a preamble having a first code for the line code word, the first code to indicate that the line code word includes the at least one control symbol; and
generate a second preamble having a second code for a second line code word, the second code to indicate that the second line code word comprises a payload symbol word.
